(19) United States
(12) Patent Application Publication
(10) Pub. No.: US 2026/0348454 A1
(43) Pub. Date: Nov. 5, 2026

(54) CONTINUOUSLY VARIABLE TRANSMISSION

(71) Applicant: Xavier PALLARÈS MATEOS, Barcelona (ES)

(72) Inventor: Xavier PALLARÈS MATEOS, Barcelona (ES)

(21) Appl. No.: 19/658,902

(22) Filed: Apr. 27, 2026

(30) Foreign Application Priority Data
Apr. 30, 2025 (EP) EP25382440

(51) Int. Cl. F16H 9/14

(52) U.S. Cl. CPC F16H 9/14

(57) ABSTRACT

Continuously variable transmission comprising a first plate (10) with a first conical convex surface (11), a second plate (20) with a second conical convex surface (21), a third plate (30) with a concave region (31), an input shaft (1), and an actuation mechanism (40) attached to the second plate (20) and comprising a plurality of pushers (41) distributed around the input shaft (1), each pusher (41) being guided by a linear guide (42) along a radial linear path tilted an acute angle, so that a centrifugal force pushes each pusher against the concave region (31), wherein the second plate (20) includes at least one first torque transmission configuration (51) slidably connected with at least one second torque transmission configuration (52) included in the third plate and/or in the input shaft (1), providing a guided movement of the second plate only in an axial direction parallel to the input shaft.

### TECHNICAL FIELD

The present invention is directed to a continuously variable transmission comprising a first plate with a first conical convex surface, a second plate with a second conical convex surface facing the first conical convex surface, and a third plate with a concave region facing the second plate. The first plate and the third plate are coaxial and fixed to an input shaft for solidary rotation therewith, and the second plate is coaxial to and axially slidable along the input shaft between the first plate and the second plate.

An actuation mechanism is attached to the second plate and includes pushers which are radially projected against the concave region of the third plate due to the centrifugal force, pushing the second plate away from the third plate.

### BACKGROUND OF THE INVENTION

Continuously variable transmission including a first plate with a first conical convex surface, a second plate with a second conical convex surface facing the first conical convex surface, and a third plate with a concave region facing the second plate are known.

In these kinds of continuously variable transmissions, the first plate and the third plate are coaxial and fixed to an input shaft for solidary rotation therewith, and the second plate is coaxial to and axially slidable along the input shaft between the first plate and the second plate, modifying the distance between the first conical convex surface and the second conical convex surface.

In these known transmissions, an actuation mechanism is attached to the second plate and includes pushers which are radially projected against the concave region of the third plate due to the centrifugal force, pushing the second plate away from the third plate.

### DESCRIPTION OF THE INVENTION

The present invention concerns a continuously variable transmission, as defined in claim 1.

The proposed continuously variable transmission comprises:
a first plate with a first conical convex surface, a second plate with a second conical convex surface facing the first conical convex surface, and a third plate with a concave region facing the second plate, the first plate and the third plate are coaxial and fixed to an input shaft for solidary rotation therewith, and the second plate is coaxial to and axially slidable along the input shaft between the first plate and the second plate; wherein
an actuation mechanism attached to the second plate and comprising a plurality of pushers distributed around the input shaft, each pusher guided by a linear guide along a radial linear path tilted an acute angle in regards an axis of the input shaft, so that a centrifugal force produced by the rotating of the actuation mechanism pushes each pusher against a concave surface of the concave region of the third plate, urging the second plate towards the first plate;
a transmission belt with trapezoidal section with a first portion confined between the first conical surface and the second conical surface and with a second portion connected to an output shaft;

According to the above, the input shaft, which is a shaft connected to a motor, rotates together with the first plate and the third plate, which are attached to the input shaft and concentric therewith.

A second plate is located between the first plate and the third plate, also concentric with the input shaft, but the second plate is not attached to the input shaft but slidably connected thereto allowing for a sliding movement of the second plate.

The first plate has a first conical convex surface and the second plate has a second conical convex surface facing the first conical convex surface.

A transmission belt with trapezoidal cross section is housed between the first conical convex surface and the second conical convex surface, preferably being the inclination of the lateral sides of the trapezoidal transmission belt coincident with the inclination of the first and second conical convex surface for an optimal contact between them.

The position of the second plate along the input shaft is controlled by an actuation mechanism. The actuation mechanism comprises linear guides attached to a back side of the second plate opposed to the side including the second conical convex surface, each linear guide guiding one pusher.

Each linear guide defines a radial linear path, which is a linear path extending in a radial direction, i.e. from the input shaft outwards, the linear path being contained in a plane also containing the axis of the input shaft.

In this case, this radial linear path defines an acute angle with the axis of the input shaft.

When the second plate rotates, the centrifugal force expels the pushers away from the input shaft along the radial linear path and, due to the inclination of the radial linear path, also expels the pushers away from the second plate.

The distal end of the pushers is in contact with the concave surface of the concave region of the third plate. The movement of the pushers away from the input shaft and away from the second plate against the concave surfaces of the third plate pushes the second plate away from the third plate, reducing the distance between the second conical convex surface and the first conical convex surface.

The present invention also proposes to include at least one first torque transmission configuration on the second plate and to include at least one second torque transmission configuration in the third plate and/or in the input shaft.

The first torque transmission configuration is slidably connected with the second torque transmission configuration, said slidably connection providing a guided movement of the second plate only in an axial direction parallel to the axis of the input shaft, preventing relative differential rotation between the second plate and the third plate.

According to the above, the first and second torque transmission configurations are connected to each other in such manner that can only slide in an axial direction parallel to the axis of the input shaft, so that a perfect coordinated rotation of the second plate with the first and third plate is ensured preventing any power loss and any accelerated wear produced by a slide of the second plate.

The above measures produces a surprising increase in the power output of the continuous variable transmission, particularly during fast accelerations, and also a surprising reduction in the maintenance requirements thereof.

Preferably, the slidably connection between the second plate and the input shaft is produced through a bearing of synthetic material integrating solid lubricating additives.

Also, the slidably connection between the at least one first torque transmission configuration and the at least one second torque transmission configuration can be produced through a bearing of synthetic material integrating solid lubricating additives.

Those bearings made of synthetic material integrating solid lubricating additives are devoid of mobile parts, and thus are easier to maintain and have a longer lifespan.

The solid lubricating additives are additives makes unnecessary the addition of oil or other liquid lubricants, preventing the soiling of the first and second convex conic surfaces with lubricant, which could potentially reduce the power transmission.

It will be understood that references to geometric position, such as parallel, perpendicular, tangent, etc. allow deviations up to ±5° from the theoretical position defined by this nomenclature.

### BRIEF DESCRIPTION OF THE FIGURES

The foregoing and other advantages and features will be more fully understood from the following detailed description of an embodiment with reference to the accompanying drawings, to be taken in an illustrative and non-limitative manner, in which:

FIG. 1 shows a longitudinal cross-section of the proposed continuously variable transmission along the axis of the input shaft, showing an upper half of the section, above the axis of the input shaft, with the second plate in the position furthest away from the first plate (10) and closest to the third plate (30), and showing a lower half of the section, below the axis of the input shaft, with the second plate in the position closest to the first plate (10) and furthest away from the third plate (30), according to a first embodiment where the continuously variable transmission includes first guided and guiding elements, and third guided and guiding elements.

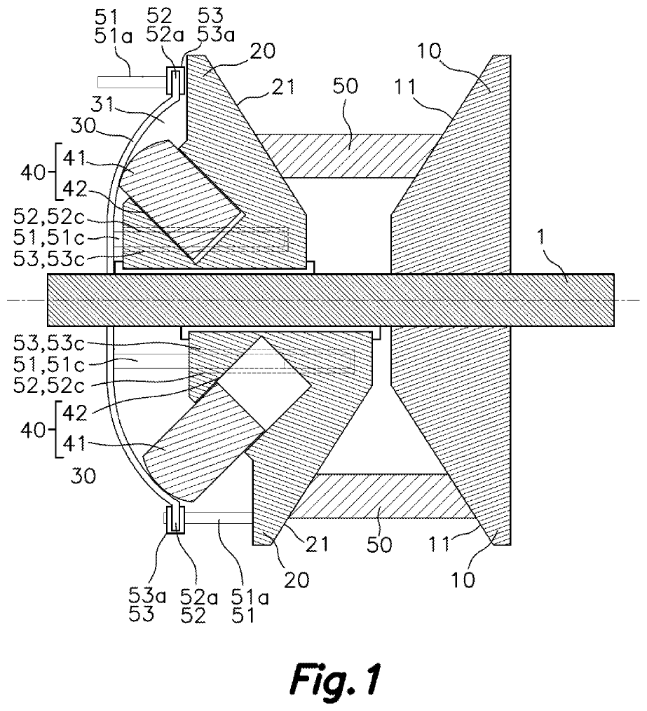

FIG. 2 shows a front view of the surface of the second plate facing the third plate, where the outer edge of the third plate is depicted with a dashed line, according to the same embodiment shown in FIG. 1.

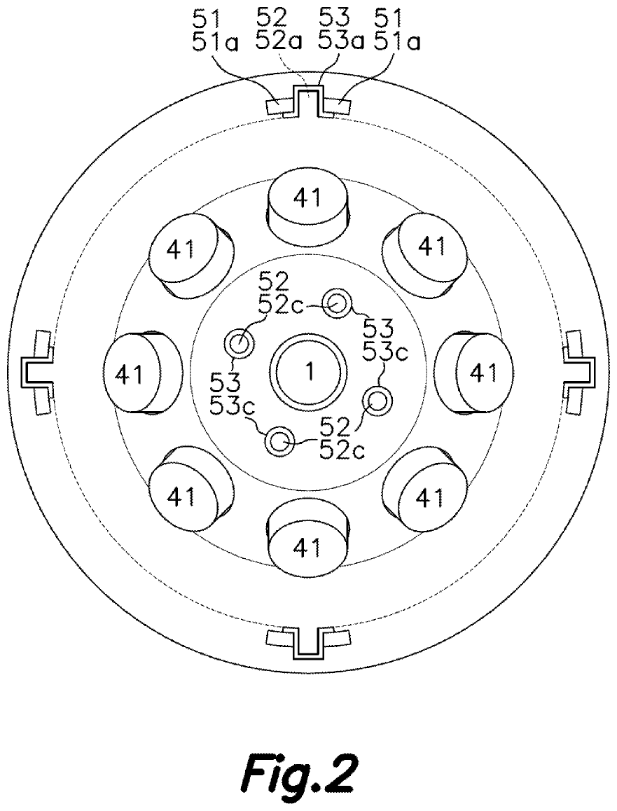

FIG. 3 shows a front view of the surface of the second plate facing the third plate, where the outer edge of the third plate is depicted with a dashed line, according to another embodiment where the continuously variable transmission includes second guided and guiding elements, and fourth guided and guiding elements.

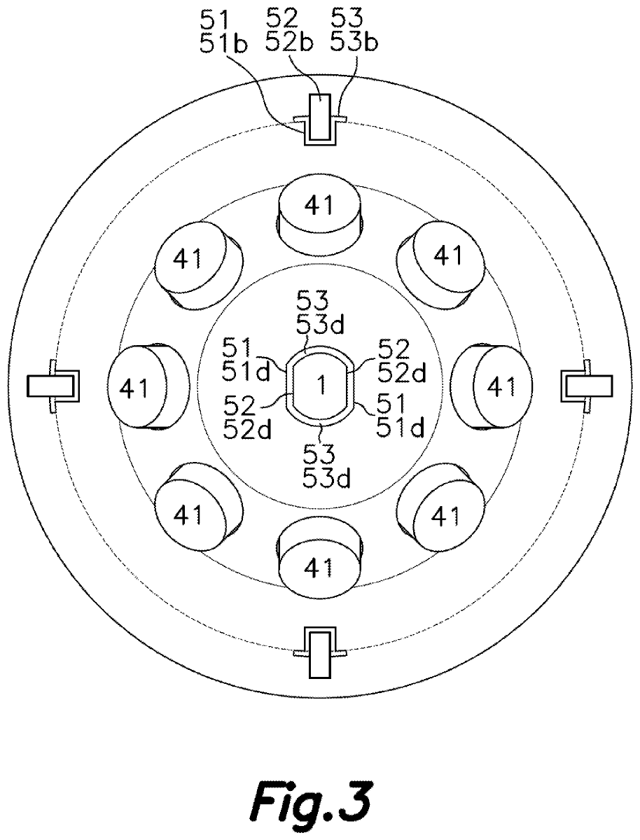

Although not shown in the figures, the present invention also covers a variable transmission with only one of the four proposed torque transmission configurations, including only first, or second, or third or fourth guided and guiding elements. Likewise, the present invention also covers any combination of said four proposed torque transmission configurations although they are not shown in the Figures.

### DETAILED DESCRIPTION OF THE INVENTION AND OF PARTICULAR EMBODIMENTS

The proposed continuously variable transmission comprises a first plate (10) with a first conical convex surface (11), a second plate (20) with a second conical convex surface (21) facing the first conical convex surface (11), and a third plate (30) with a concave region (31) facing the second plate (20).

The first plate (10) and the third plate (30) are coaxial and fixed to an input shaft (1) for solidary rotation therewith.

The second plate (20) is coaxial to and axially slidable along the input shaft (1) between the first plate (10) and the third plate (30).

An actuation mechanism (40) is attached to the second plate (20) and comprises a plurality of pushers (41) distributed around the input shaft (1).

Each pusher (41) is guided by a linear guide (42) along a radial linear path tilted an acute angle in regards an axis of the input shaft (1), so that a centrifugal force produced by the rotating of the actuation mechanism (40) pushes each pusher (41) against a concave surface of the concave region (31) of the third plate (30), urging the second plate (20) away the third plate (30) and towards the first plate (10).

The continuously variable transmission further comprises a transmission belt (50) with trapezoidal cross section. A first portion of the transmission belt is confined between the first conical surface (11) and the second conical surface (21) and a second portion of the transmission belt is connected to an output shaft, which typically is parallel to the input shaft.

According the proposed invention, the second plate (20) includes at least one first torque transmission configuration (51), and the third plate (30) and/or in the input shaft (1) includes at least one second torque transmission configuration (52).

The at least one first torque transmission configuration (51) is slidably connected to the at least one second torque transmission configuration (52), said slidably connection providing a guided movement of the second plate (20) only in an axial direction parallel to the axis of the input shaft (1), preventing relative differential rotation between the second plate (20) and the third plate (30).

The slidably connection between the second plate (20) and the input shaft (1) can be produced, for example, through a bearing of synthetic material integrating solid lubricating additives.

Similarly, the slidably connection between the at least one first torque transmission configuration (51) and the at least one second torque transmission configuration (52) can also be produced through a bearing of synthetic material integrating solid lubricating additives.

Optionally, the actuation mechanism (40) can be completely contained within the concave region of the third plate (30) when the second plate (20) is furthest away from the first plate (10) and closest to the third plate (30), resulting in a very compact device.

According to a first embodiment of the present invention, the at least one first torque transmission configuration (51) comprise first guided elements (51a), for example shaped as a channel or as a groove, each first guided elements (51a) being elongated in a direction parallel to the axis of the input shaft (1), disposed around the outer edge of the third plate (30). In this case, the at least one second torque transmission configuration (52) will comprise first guiding elements (52a) projecting from an outer edge of the third plate (30) in a radial direction regarding the input shaft (1).

According to this first embodiment, each first guiding element (52a) is contained within one first guided element (51a), which defines a channel or a groove, for a guided movement thereof, and a first bearing (53a) is included between each first guiding element and the corresponding first guided element.

In this first embodiment, each first guided element (51a) may comprise left and right guided elements arranged at different angular positions around the input shaft (1), defining said channel or groove in between, with the first guiding element (52a) retained between the left and right guided elements. In this case, the third plate (30) will be surrounded by all the left and right guided elements.

Each first bearing (53a) may be installed around one first guiding element (52a) and may include an elastically deformable retention pawl inserted in a housing of the first guiding element (52a) preventing the extraction of the first bearing (53a) from the first guiding element (52a) in a radial direction regarding the input shaft (1).

According to a second embodiment, the first torque transmission configurations (51) comprise second guided elements (51b), each defining a guide channel elongated in a direction parallel to the axis of the input shaft (1), disposed around the outer edge of the third plate (30), and the second torque transmission configurations (52) comprise second guiding elements (52b) arranged in an outer edge of the third plate (30), each second guiding element (52b) containing one second guided element (51b) for a guided movement thereof.

In this case, a second bearing (53b) is included between each second guiding element (52b) and the corresponding second guided element (51b).

According to the above, in the first embodiment the first guiding elements (52a) are contained within the first guided elements (51a), and the second embodiment is an inverted construction in which the second guided elements (51b) are contained within the second guiding elements (52b).

Optionally, each first bearing (53a) may include a portion thereof tightly confined between the third plate (30) and the first guided element (51a), and/or each second bearing (53b) may include a portion thereof tightly confined between the third plate (30) and the second guided element (51b).

According to a third embodiment of the present invention, the first torque transmission configurations (51) may comprise third guided elements (51c), each defining a guiding channel elongated in a direction parallel to the axis of the input shaft (1), defined by perforations of the second plate (20) arranged adjacent and around the input shaft (1). In this case, the second torque transmission configurations (52) will comprise third guiding elements (52c) projecting from the concave region (31) of the third plate (30) in a direction parallel to the axis of the input shaft (1), each third guiding element (52c) being contained within one third guided element (51c) for a guided movement thereof.

A third bearing (53c) will be included between each third guiding element (52c) and the corresponding third guided element (51c).

Preferably, the third guided elements (51c) are closer to the input shaft (1) than the linear guides (42) of the actuation mechanism (40).

According to a fourth embodiment of the present invention, the first torque transmission configurations (51) may comprise fourth guided elements (51d), each defined by a flat surface of a non-circular central through hole of the second plate (20) containing the input shaft (1), each flat surface being parallel to the axis of the input shaft (1). In this case, the second torque transmission configurations (52) will comprise fourth guiding elements (52d), each defined by a flat surface of the input shaft (1) parallel to the axis of the input shaft (1), each flat surface of the fourth guided element (51d) facing one flat surface of the fourth guiding elements (52d) for a guided movement thereof..

A fourth bearing (53d) will be included between each fourth guiding element (52d) and the corresponding fourth guided element (51d).

The non-circular central through hole of the second disc, in cooperation with the flat surfaces of the input shaft provides a torque transmission configuration which allows only the sliding movement of the second disc along the input shaft but not a relative rotation.

Optionally, the at least one first torque transmission configuration (51) comprises several first torque transmission configurations (51) radially distributed around the input shaft, and the at least one second torque transmission configuration (52) comprises several second torque transmission configurations (52) radially distributed around the input shaft (1) in correspondence with the first torque transmission configurations (51).

1. Continuously variable transmission comprising:
a first plate (10) with a first conical convex surface (11), a second plate (20) with a second conical convex surface (21) facing the first conical convex surface (11), and a third plate (30) with a concave region (31) facing the second plate (20), the first plate (10) and the third plate (30) are coaxial and fixed to an input shaft (1) for solidary rotation therewith, and the second plate (20) is coaxial to and axially slidable along the input shaft (1) between the first plate (10) and the third plate (30); wherein
an actuation mechanism (40) attached to the second plate (20) and comprising a plurality of pushers (41) distributed around the input shaft (1), each pusher (41) being guided by a linear guide (42) along a radial linear path tilted an acute angle in regards an axis of the input shaft (1), so that a centrifugal force produced by the rotating of the actuation mechanism (40) pushes each pusher (41) against a concave surface of the concave region (31) of the third plate (30), urging the second plate (20) towards the first plate (10);
a transmission belt (50) with trapezoidal section with a first portion confined between the first conical surface (11) and the second conical surface (21) and with a second portion connected to an output shaft;
characterized in that
the second plate (20) includes at least one first torque transmission configuration (51) slidably connected with at least one second torque transmission configuration (52) included in the third plate (30) and/or in the input shaft (1), said slidably connection between the first and second torque transmission configurations (51, 52) providing a guided movement of the second plate (20) only in an axial direction parallel to the axis of the input shaft (1), preventing relative differential rotation between the second plate (20) and the third plate (30).

2. The continuously variable transmission according to claim 1 wherein the slidably connection between the second plate (20) and the input shaft (1) is produced through a bearing of synthetic material integrating solid lubricating additives.

3. The continuously variable transmission according to claim 1 or 2 wherein the slidably connection between the at least one first torque transmission configuration (51) and the at least one second torque transmission configuration (52) is produced through a bearing of synthetic material integrating solid lubricating additives.

4. The continuously variable transmission according to claim 1, 2 or 3 wherein the actuation mechanism (40) is completely contained within the concave region of the third plate (30) when the second plate (20) is closest to the third plate (30).

5. The continuously variable transmission according to any preceding claim wherein the at least one first torque transmission configuration (51) comprise first guided elements (51a), each elongated in a direction parallel to the axis of the input shaft (1), disposed around the outer edge of the third plate (30) and attached thereto;
the at least one second torque transmission configuration (52) comprise first guiding elements (52a) projecting from an outer edge of the third plate (30) in a radial direction regarding the input shaft (1), each first guiding element (52a) being contained within one first guided element (51a) for a guided movement thereof; and
a first bearing (53a) is included between each first guiding element and the corresponding first guided element.

6. The continuously variable transmission according to claim 5 wherein each first guided element (51a) comprises left and right guided elements arranged at different angular positions around the input shaft (1), the third plate (30) being surrounded by all the left and right guided elements.

7. The continuously variable transmission according to claim 6 wherein each first bearing (53a) surround one first guiding element (52a) and includes an elastically deformable retention pawl inserted in a housing of the first guiding element (52a) preventing the extraction of the first bearing (53a) from the first guiding element (52a) in a radial direction regarding the input shaft (1).

8. The continuously variable transmission according to any preceding claim 1 to 4 wherein
the first torque transmission configurations (51) comprise second guided elements (51b), each defining a guide channel elongated in a direction parallel to the axis of the input shaft (1), disposed around the outer edge of the third plate (30) and integrated therein;
the second torque transmission configurations (52) comprise second guiding elements (52b) arranged in an outer edge of the third plate (30), each second guiding element (52b) containing one second guided element (51b) for a guided movement thereof; and
a second bearing (53b) is included between each second guiding element (52b) and the corresponding second guided element (51b).

9. The continuously variable transmission according to claim 5, 6 or 7 wherein each first bearing (53a) includes a portion thereof tightly confined between the third plate (30) and the first guided element (51a), and/or wherein each second bearing (53b) includes a portion thereof tightly confined between the third plate (30) and the second guided element (51b).

10. The continuously variable transmission according to any preceding claim wherein
the first torque transmission configurations (51) comprise third guided elements (51c), each defining a guiding channel elongated in a direction parallel to the axis of the input shaft (1), defined by perforations of the second plate (20) arranged adjacent and around the input shaft (1);
the second torque transmission configurations (52) comprise third guiding elements (52c) projecting from the concave region (31) of the third plate (30) in a direction parallel to the axis of the input shaft (1), each third guiding element (52c) being contained within one third guided element (51c) for a guided movement thereof; and
a third bearing (53c) is included between each third guiding element (52c) and the corresponding third guided element (51c).

11. The continuously variable transmission according to claim 10 wherein the third guided elements (51c) are closer to the input shaft (1) than the linear guides (42) of the actuation mechanism (40).

12. The continuously variable transmission according to any preceding claim wherein
the first torque transmission configurations (51) comprise fourth guided elements (51d), each defined by a flat surface of a non-circular central through hole of the second plate (20) containing the input shaft (1), each flat surface being parallel to the axis of the input shaft (1);
the second torque transmission configurations (52) comprise fourth guiding elements (52d), each defined by a flat surface of the input shaft (1) parallel to the axis of the input shaft (1), each flat surface of the fourth guided element (51d) facing one flat surface of the fourth guiding elements (52d) for a guided movement thereof; and
a fourth bearing (53d) is included between each fourth guiding element (52d) and the corresponding fourth guided element (51d).

13. The continuously variable transmission according to any preceding claim wherein the at least one first torque transmission configuration (51) comprises several first torque transmission configurations (51) radially distributed around the input shaft, and wherein the at least one second torque transmission configuration (52) comprises several second torque transmission configurations (52) radially distributed around the input shaft (1) in correspondence with the first torque transmission configurations (51).
